(19) United States
(12) Patent Application Publication
(10) Pub. No.: US 2005/0255434 A1
(43) Pub. Date: Nov. 17, 2005

(54) Interactive virtual characters for training including medical diagnosis training

(75) Inventors: Benjamin Lok, Gainesville, FL (US); Scott Lind, Gainesville, FL (US)

Correspondence Address: AKERMAN SENTERFITT, P.O. BOX 3188, WEST PALM BEACH, FL, 33402-3188, US

(73) Assignee: UNIVERSITY OF FLORIDA RESEARCH FOUNDATION, INC.

(21) Appl. No.: 11/067,934

(22) Filed: Feb. 28, 2005

Related U.S. Application Data
(60) Provisional application No. 60/548,463, filed on Feb. 27, 2004.

(51) Int. Cl. G09B 23/28

(52) U.S. Cl. 434/262

(57) ABSTRACT

An interactive training system includes computer vision provided by at least one video camera for obtaining trainee image data, and pattern recognition and image understanding algorithms to recognize features present in the trainee image data to detect gestures of the trainee. Graphics coupled to a display device is provide for rendering images of at least one virtual individual. The display device is viewable by the trainee. A computer receives the trainee image data or gestures of the trainee, and optionally the voice of the trainee, and implements an interaction algorithm. An output of the interaction algorithm provides data to the graphics and moves the virtual character to provide dynamically alterable images of the virtual character, as well as well as an optional virtual voice. The virtual individual can be a medical patient, where the trainee practices diagnosis on the patient.

### CROSS-REFERENCE TO RELATED APPLICATIONS

This applications claims the benefit of U.S. Provisional Application No. 60/548,463 entitled “INTERACTIVE VIRTUAL CHARACTERS FOR MEDICAL DIAGNOSIS TRAINING” filed Feb. 27, 2004, and incorporates the same by reference in its entirety.

### STATEMENT REGARDING FEDERALLY SPONSORED RESEARCH OR DEVELOPMENT

Not applicable.

### FIELD OF THE INVENTION

The invention relates to interactive communication skills training systems which utilize natural interaction and virtual characters, such as simulators for medical diagnosis training.

### BACKGROUND

Communication skills are important in a wide variety of personal and business scenarios. In the medical area, good communication skills are often required to obtain an accurate diagnosis for a patient.

Currently, medical professionals have difficulty in training medical students and residents for many critical medical procedures. For example, diagnosing a sharp pain in one's side, generally referred to as an acute abdomen (AA) diagnosis, conventionally involves first asking a patient a series of questions, while noting both their verbal and gesture responses (e.g. pointing to an affected area of the body). Training is currently performed by practicing on standardized patients (trained actors) under the observation of an expert. During training, the expert can point out missed steps or highlight key situations. Later, trainees are slowly introduced to real situations by first watching an expert with an actual patient, and then gradually performing the principal role themselves. These training methods lack scenario variety (experience diversity), opportunities (repetition), and standardization of experiences across students (quality control). As a result, most medical residents are not sufficiently proficient in a variety of medical diagnostics when real situations eventually arise.

### SUMMARY

An interactive training system comprises computer vision including at least one video camera for obtaining trainee image data, and pattern recognition and image understanding algorithms to recognize features present in the trainee image data to detect gestures of the trainee. Graphics coupled to a display device is provided for rendering images of at least one virtual individual. The display device is viewable by the trainee. A computer receives the trainee image data or gestures of the trainee, and optionally the voice of the trainee, and implements an interaction algorithm. An output of the interaction algorithm provides data to the graphics and moves the virtual character to provide dynamically alterable animated images of the virtual character responsive to the trainee image data or gestures of the trainee, together with optional pre-recorded or synthesized voices. The virtual individual are preferably life size and 3D.

The system can include voice recognition software, wherein information derived from a voice of the trainee received is provided to the computer for inclusion in the interaction algorithm. In one embodiment of the invention, the system further comprises a head tracking device and/or a hand tracking device to be worn by the trainee. The tracking devices improve recognition of trainee gestures.

The system can be an interactive medical diagnostic training system and method for training a medical trainee, where the virtual individuals include one or more medical instructors and patients. The trainee can thus practice diagnosis on the virtual patient while the virtual instructor interactively provides guidance to the trainee. In a preferred embodiment, the computer includes storage of a bank of pre-recorded voice responses to a set of trainee questions, the voice responses provided by a skilled medical practitioner.

A method of interactive training comprises the steps of obtaining trainee image data of a trainee using computer vision and trainee speech data from the trainee using speech recognition, recognizing features present in the trainee image data to detect gestures of the trainee, and rendering dynamically alterable images of at least one virtual individual. The dynamically alterable images are viewable by the trainee, wherein the dynamically alterable images are rendered responsive to the trainee speech and trainee image data or gestures of the trainee. In one embodiment, the virtual individual is a medical patient, the trainee practicing diagnosis on the patient. The virtual individual preferably provides speech, such as from a bank of pre-recorded voice responses to a set of trainee questions, the voice responses provided by a skilled medical practitioner.

### BRIEF DESCRIPTION OF THE DRAWINGS

A fuller understanding of the present invention and the features and benefits thereof will be accomplished upon review of the following detailed description together with the accompanying drawings, in which:

FIG. 1 shows an exemplary interactive communication skills training system which utilizes natural interaction and virtual individuals as a simulator for medical diagnosis training, according to an embodiment of the invention.

FIG. 2 shows head tracking data indicating where a medical trainee has looked during an interview. This trainee looked mostly at the virtual patient's head and thus maintained a high level of eye-contact during the interview.

### DETAILED DESCRIPTION

An interactive medical diagnostic training system and method for training a trainee comprises computer vision including at least one video camera for obtaining trainee image data, and a processor having pattern recognition and image understanding algorithms to recognize features present in the trainee image data to detect gestures of the trainee. One or more virtual individuals are provided in the system, such as customer(s) or medical patient(s). The system includes computer graphics coupled to a display device for rendering images of the virtual individual(s). The virtual individuals are viewable by the trainee. The virtual individuals also preferably include a virtual instructor, the instructor interactively providing guidance to the trainee through at least one of speech and gestures derived from movement of images of the instructor. The virtual individuals can interact with the trainee during training through speech and/or gestures.

As used herein, “computer vision” or “machine vision” refers to a branch of artificial intelligence and image processing relating to computer processing of images from the real world. Computer vision systems generally include one or more video cameras for obtaining image data, an analog-to-digital conversion (ADC), and digital signal processing (DSP) and associated computer for processing, such as low level image processing to enhance the image quality (e.g. to remove noise, and increase contrast), and higher level pattern recognition and image understanding to recognize features present in the image.

In a preferred embodiment of the invention, the display device is large enough to provide life size images of the virtual individual(s). The display devices preferably provide 3D images.

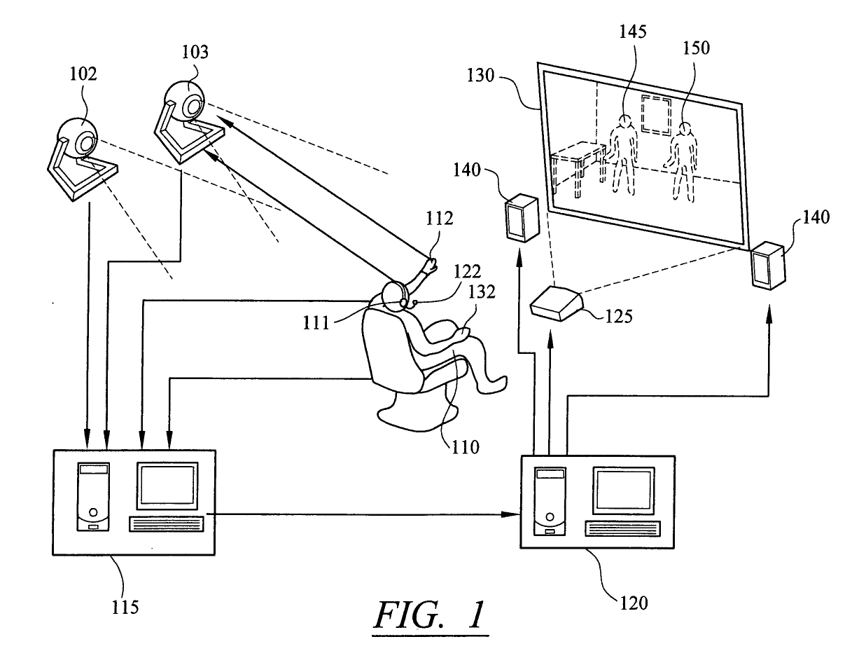

FIG. 1 shows an exemplary interactive communication skills training system 100 which utilizes natural interaction and virtual individuals as a simulator for medical diagnosis training in an examination room, according to an embodiment of the invention. Although the components comprising system 100 are generally shown as being connected by wires in FIG. 1, some or all of the system communications can alternatively be over the air, such optical and/or RF links.

The system 100 includes computer vision provided by at least one camera, and preferably two cameras 102 and 103. The cameras can be embodied as webcams 102 and 103. Webcams 102 and 103 track the movements of trainee 110 and provide dynamic image data of trainee 110. The trainee speaks into a microphone 122. An optional tablet PC 132 is provided to deliver the patient's vital signs on entry, and for note taking.

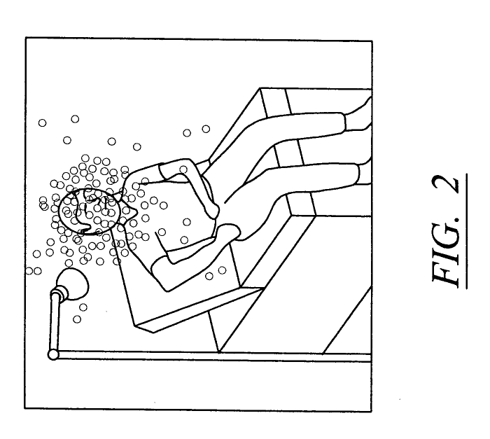

Trainee 110 is preferably provided a head tracking device 111 and hand tracking device 112 to wear during training. The head tracking device 111 can comprise a headset with custom LED integration for head tracking, and a glove with custom LED integration for hand tracking. The LED color(s) on tracking device 111 are preferably different as compared to the LED color(s) on tracking device 112. The separate LED-based tracking devices 111 and 112 provide enhanced ability to recognize gestures of trainee 110, such as handshaking and pointing (e.g. “Does it hurt here?”) by following the LED markers on the head and hand of trainee 110. The tracking system can continuously transmit tracking information to the system 100. To capture movement information regarding trainee 100, the webcams 102 and 103 preferably track both images including trainee 110 as well as movements of the LED markers in device 111 and 112 for improved perspective-based rendering and gesture recognition. Head tracking also allows rendering of the virtual individuals from the perspective of the trainee 110 (rendering explained below), as well as an approximate measurement of head and gaze behavior of trainee 110 (see FIG. 2 below).

Image processor 115 is shown embodied as a personal computer 115, which receives the trainee image and LED derived hand and head position image data from webcams 102 and 103. Personal computer 115 also includes pattern recognition and image understanding algorithms to recognize features present in the trainee image data and hand and head image data to detect gestures of the trainee 110, allowing extraction of 3D information regarding motion of the trainee 110, including dynamic head and hand positions.

The head and hand position data generated by personal computer 115 is provided to a second processor 120, embodied again as a personal computer 120. Although shown as separate computing systems in FIG. 1, it is possible to combine personal computers 115 and 120 into a single computer or other processor. Personal computer 120 also receives audio input from trainee 110 via microphone 122.

Personal computer 120 includes a speech manager which includes speech recognition software, such as the DRAGON NATURALLY SPEAKING PRO™ engine (ScanSoft, Inc.) engine for recognizing the audio data from the trainee 110 via microphone 122. Personal computer 120 also stores a bank of pre-recorded voice responses to a large plurality of what are considered the complete set of reasonable trainee questions, such as provided by a skilled medical practitioner.

Personal computer 120 also preferably includes gesture manager software for interpreting gesture information. Personal computer 120 can thus combine speech and gesture information from trainee 110 to generate image data to drive data projector 125 which includes graphics for generating virtual character animation on display screen 130. The display screen 130 is positioned to be readily viewable by the trainee 110.

The display screen 130 renders images of at least one virtual individual, such as images of virtual patient 145 and virtual instructor 150. Haptek Inc (Watsonville, Calif.) virtual character software or other suitable software can be used for this purpose. As noted above, personal computer 120 also provides voice data associated with the bank of responses to drive speaker 140 responsive to researched gesture and audio data. Speaker 140 provides voice responses from patient 145 and/or optional instructor 150. Corrective suggestions from instructor 150 can be used to facilitate learning.

Trainee gestures are designed to work in tandem with speech from trainee 110. For example, when the speech manager in computer 120 receives the question “Does it hurt here?”, it preferably also queries the gesture manager to see if the question was accompanied by a substantially contemporaneous gesture (ie. Pointed to the lower right abdomen), before matching a response from the stored bank of responses. Gestures can have targets since scene objects and certain parts of the anatomy of patient 145 can have identifiers. Thus, a response to a query by trainee 110 can involve consideration of both his or her audio and gestures. In a preferred embodiment, system 100 thus understands a set of natural language and is able to interpret movements (e.g. gestures) of the trainee 110, and formulate responsive audio and image data in response to the verbal and non-verbal cues received.

Applied to medical training in a preferred embodiment, the trainee practices diagnosis on a virtual patient while the virtual instructor interactively provides guidance to the trainee. The invention is believed to be the first to provide a simulator-based system for practicing medical patient-doctor oral diagnosis. Such a system will provide an effective training aid for teaching diagnostic skills to medical trainees and other trainees.

FIG. 2 shows head tracking data indicating where the medical trainee has looked during an interview. The data demonstrates that the trainee looked mostly at the virtual patient's head and thus maintained a high level of eye-contact during the interview.

Systems according to the invention can be used as training tools for a wide variety of medical procedures, which include diagnosis and interpersonal communication, such as delivering bad news, or improving doctor-patient interaction. Virtual individuals also enable more students to practice procedures more frequently, and on more scenarios. Thus, the invention is expected to directly and significantly improve medical education and patient care quality.

As noted above, although the invention is generally described relative to medical training, the invention has broader applications. Other exemplary applications include non-medial training, such as gender diversity, racial sensitivity, job interview, and customer care, that each require practicing oral communication with other people. The invention may also have military applications. For example, the virtual individuals provided by the invention can train soldiers regarding the behavioral norms for individuals from various parts of the world act responsive to certain actions or situations, such as drawing a gun or interrogation.

It is to be understood that while the invention has been described in conjunction with the preferred specific embodiments thereof, that the foregoing description as well as the examples which follow are intended to illustrate and not limit the scope of the invention. Other aspects, advantages and modifications within the scope of the invention will be apparent to those skilled in the art to which the invention pertains.

1. An interactive training system, comprising:
computer vision including at least one video camera for obtaining trainee image data;
a processor providing pattern recognition and image understanding algorithms to recognize features present in said trainee image data to detect gestures of said trainee;
graphics coupled to a display device for rendering images of at least one virtual individual, said display device viewable by said trainee, and
a computer receiving said trainee image data or said gestures of said trainee, said computer implementing an interaction algorithm, an output of said interaction algorithm providing data to said graphics, said output data moving said virtual individual to provide dynamically alterable images of said virtual individual responsive to said trainee image data or said gestures of said trainee.

2. The system of claim 1, further comprising voice recognition software, wherein information derived from a voice from said trainee received is provided to said computer for inclusion in said interaction algorithm.

3. The system of claim 1, further comprising at least one of a head tracking device and a hand tracking device worn by said trainee, said tracking device improving recognition of said gestures of said trainee.

4. The system of claim 1, further comprising a speech synthesizer coupled to a speaker to provide said virtual individual a voice, wherein said interaction algorithm provides voice data to said speech synthesizer based on said image data and said gestures.

5. The system of claim 1, wherein said virtual individual is a medical patient, said trainee practicing diagnosis on said patient.

6. The system of claim 5, wherein said computer includes storage of a bank of pre-recorded voice responses to a set of trainee questions, said voice responses provided by a skilled medical practitioner.

7. The system of claim 1, wherein images of said virtual individual are life size and 3D.

8. The system of claim 1, wherein said at least one virtual individual includes a virtual instructor, said virtual instructor interactively providing guidance to said trainee.

9. A method of interactive training, comprising the steps of:
obtaining trainee image data of a trainee using computer vision and trainee speech data from said trainee using speech recognition,
recognizing features present in said trainee image data to detect gestures of said trainee, and
rendering dynamically alterable images of at least one virtual individual, said dynamically alterable images viewable by said trainee, wherein said dynamically alterable images are rendered responsive to said trainee speech and said trainee image data or said gestures of said trainee.

10. The method of claim 9, wherein said virtual individual provides synthesized speech.

11. The method of claim 9, wherein said virtual individual is a medical patient, said trainee practicing diagnosis on said patient.

12. The method of claim 11, wherein said virtual speech is derived from a bank of pre-recorded voice responses to a set of trainee questions, said voice responses provided by a skilled medical practitioner.

13. The method of claim 9, wherein said virtual individual is life size and said dynamically alterable images are 3-D images.

14. The method of claim 9, wherein said step of obtaining trainee image data comprises attaching at least one of a head tracking device and a hand tracking device to said trainee.

15. The method of claim 9, wherein said at least one virtual individual includes a virtual instructor, said virtual instructor interactively providing guidance to said trainee.
